(19) United States
(12) Patent Application Publication
(10) Pub. No.: US 2017/0097119 A1
(43) Pub. Date: Apr. 6, 2017

(54) CRYOGENIC TANK WITH INTERNAL HEAT EXCHANGER AND FAIL-CLOSED VALVE

(71) Applicant: Taylor-Wharton Cryogenics LLC, Minnetonka, MN (US)

(72) Inventor: CLAUS EMMER, Prior Lake, MN (US)

(21) Appl. No.: 15/206,936

(22) Filed: Jul. 11, 2016

Related U.S. Application Data
(60) Provisional application No. 62/190,824, filed on Jul. 10, 2015.

(51) Int. Cl. F17C 7/02; F17C 3/00

(52) U.S. Cl. CPC F17C 7/02; F17C 3/005; F17C 2221/033; F17C 2227/0309; F17C 2205/0323; F17C 2223/013; F17C 2223/0123; F17C 2270/0168

(57) ABSTRACT

A cryogenic tank system includes a plurality of heat exchangers for heating an interior volume of a storage container. Heat transfer to the interior volume of the storage container by the plurality of heat exchangers pressurizes the interior volume of the storage container. The system further includes a valve assembly mounted to the storage container and positioned substantially within the storage container. The valve assembly includes an inlet portion and an outlet portion. The outlet portion is positioned outside of the storage container, and the inlet portion is positioned within the storage container. The inlet portion is sealable by a fail-closed powered sealing mechanism.

### CROSS REFERENCE TO RELATED APPLICATION

The present application claims priority to U.S. Ser. No. 62/190,824, titled CRYOGENIC TANK WITH INTERNAL HEAT EXCHANGER AND FAIL-CLOSED VALVE, filed on Jul. 10, 2015, the disclosure of which is hereby incorporated by reference in its entirety.

### BACKGROUND

Storage tanks for cryogenic fluids often employ submerged pumps to facilitate the removal of liquid for use. However, submerged pumps can cause a plethora of issues, including increasing the overall cost of the cryogenic tank. Additionally, pumps require regular maintenance and are often hard to access when submerged within a storage tank. The removal of, and the maintenance on, such pumps can cause significant downtime for the storage tank, thereby stalling any removal of cryogenic fluid stored. Also, pumps must sit within a pump sump within the tank when submerged, the access nozzle that holds the pump is required to be quite large to allow for removal of the pump. Because of the large size of the access nozzle into the tank, the tank must be made out of thicker, specially treated materials to fall within certain pressure vessel certifications (i.e. ASME).

Therefore, improvements in pumping systems for cryogenic tanks are desired.

### SUMMARY

The present disclosure generally relates to cryogenic tanks for liquid natural gas storage in addition to the atmospheric gases. More particularly, the present disclosure relates to cryogenic system using internal heat exchangers to facilitate the removal of liquid natural gas (LNG) from the cryogenic tank as well as to control the temperature of the liquid stored in the tank.

One aspect of the present disclosure generally relates to a cryogenic tank system.

The cryogenic tank system includes a storage container that has a top portion and a bottom portion. The storage container also is configured to store a liquid within an enclosed interior volume. A level of the liquid within the interior volume defines a liquid space and a vapor space. The cryogenic tank system also includes a heat exchanger arrangement that includes a heat exchanger heater positioned external to the storage container and connected to a heat exchanger fluid circuit. The arrangement further includes a first heat exchanger located in the vapor space within the storage container and in fluid communication with the heat exchanger heater along the heat exchanger fluid circuit. Also, the arrangement includes a second heat exchanger located in the liquid space within the storage container and in fluid communication with the heat exchanger heater along the heat exchanger fluid circuit. Heat transfer to the vapor space and the liquid space by the first and second heat exchangers pressurizes the interior volume of the storage container. The cryogenic tank system further includes a valve assembly mounted to the top portion of the storage container and positioned substantially within the storage container. The valve assembly includes an inlet portion and an outlet portion. The outlet portion is positioned outside of the storage container, and the inlet portion is positioned within the storage container proximate to the bottom portion of the storage container. The inlet portion is sealable by a fail-closed powered sealing mechanism. In some examples, the fail-closed powered sealing mechanism is generally located inside the tank.

Another aspect of the present disclosure relates to a method of removing a fluid from a cryogenic storage container. The method includes heating a heat exchanger fluid at a heat exchanger heater. The heat exchanger heater is positioned externally to the cryogenic storage container and connected to a heat exchanger fluid circuit. The method also includes pressurizing the storage container by transferring heat from a first heat exchanger positioned within the vapor space of the storage container and connected to the heat exchanger fluid circuit. Further, the method includes opening an inlet portion of a valve assembly by delivering power to a fail-closed powered sealing mechanism positioned at the inlet portion of the valve assembly. The method also includes withdrawing a fluid from an outlet portion of the valve assembly.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 is a schematic drawing of a cryogenic storage system, according to one embodiment of the present disclosure; and

FIG. 2 is a schematic drawing of a fail-closed valve, according to one embodiment of the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The present disclosure applies generally to a cryogenic system that utilizes a heat exchanger arrangement to pressurize a vessel for cryogenic liquid removal. The present disclosure also relates to a small, powered, fail-closed valve that can operate immersed in a cryogenic storage tank. In some embodiments, the valve system is generally smaller than 3 inches in diameter. The most immediate application is in liquid natural gas (LNG) storage systems, where the ability to shut off the flow of liquid within the tank meets and exceeds the safety requirements and standards that are required of such LNG systems. By removing the need for a pump, substantial cost savings may be achieved in the system. Additionally, the elimination of potentially time-consuming pump maintenance lowers operation costs and is a lower-hassle solution than a pump powered cryogenic tank system. Further, the present disclosure relates generally to a method of withdrawing liquid or gas from a cryogenic storage tank that has top-only penetrations for increased safety to the environment, surrounding people, equipment, and property.

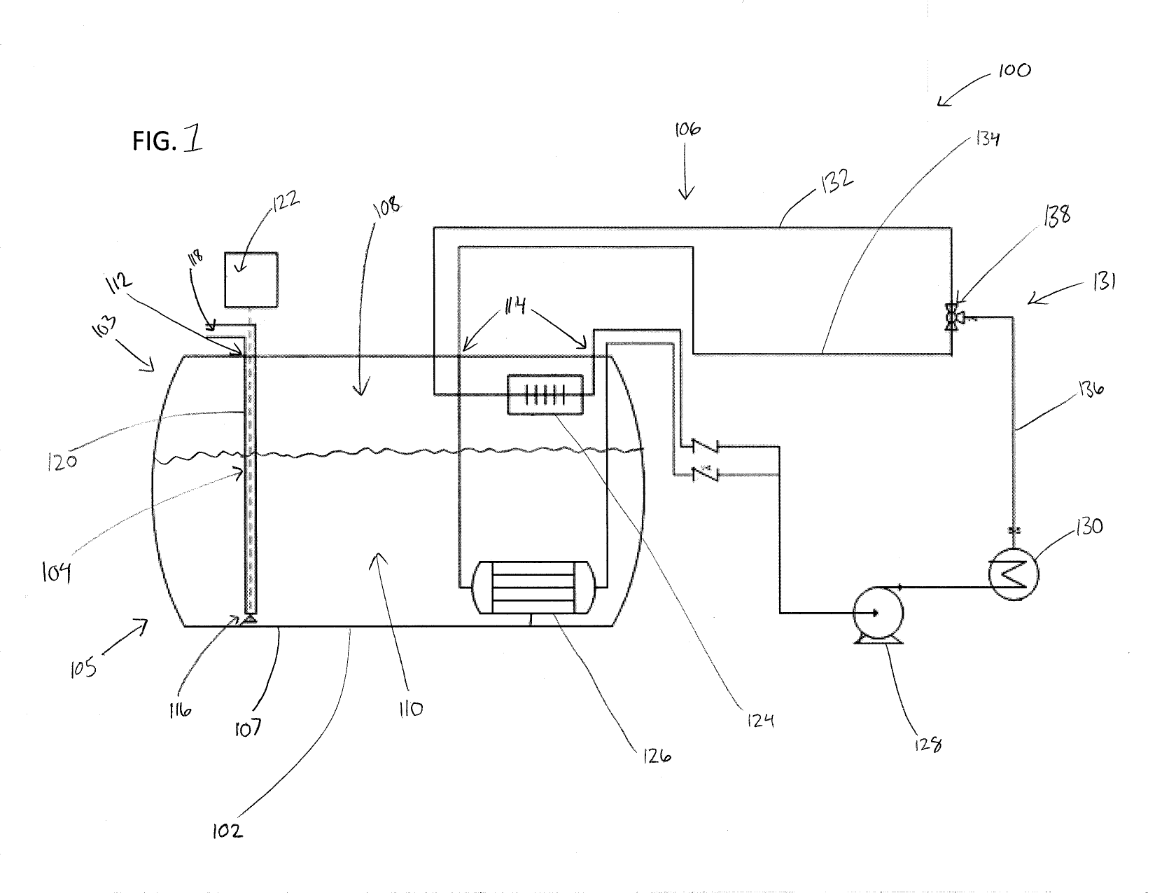

FIG. 1 shows a schematic view of a cryogenic storage system 100. The system 100 includes a storage tank 102, a fail-closed valve 104 situated within the tank 102, and a heat exchanger arrangement 106. The heat exchanger arrangement 106 is configured to transfer heat into the storage tank 102 to pressurize the storage tank 102. Once a desired pressure is reached, the fail-closed valve 104 is opened and the pressure from within the tank 102 forces fluid from within the tank 102, through the fail-closed valve 104 and to a location outside of the tank 102.

The tank 102 is configured to store a cryogenic fluid, specifically LNG, in both a vapor form and a liquid form. The tank 102, stores the vapor (gas) LNG in a vapor space 108 and the liquid LNG in a liquid space 110. The level of the liquid within the tank 102 defines the liquid space 110 and the vapor space 108. In some embodiments, the tank 102 can include an outer jacket (not shown) surrounding an inner tank (not shown). Additionally, a variety of different transportation features (i.e. a skid, skids, or attachment hooks) can be secured to tank 102 to facilitate transport to dispensing sites. In some embodiments, the tank 102 may be manufactured to be safely transported via truck or train, or, alternatively, safely buried underground.

As shown, the tank 102 includes the valve 104 which enters the tanks at a valve access point 112, shown positioned in a top 103 portion of the tank 102. Additionally, access points 114 for the heat exchanger arrangement 106 are also positioned near or at the top 103 of the tank 102. By locating all access points 112 and 114 near or at the top 103 of the tank 102, the possibility for a liquid spill is reduced. This is due to the fact that all access points 112, 114 enter the tank 102 and immediately pass into the vapor space 108, rather than a liquid space 110. Therefore, if a failure occurs at an access point 112, 114 only vapor LNG is released. In normal operation when the tank 102 is sitting upright, the top portion 103 is further away from a surface the tank 102 is resting on than the bottom portion 105.

In some embodiments, the tank 102 includes a pressure relief system. Such a system can be configured to open and vent gas from within the tank to the outside of the tank once the interior of the tank surpasses a threshold pressure. In some embodiments, the tank is vented to a flare stack for safety precautions.

The fail-closed valve 104 is configured to pass through the valve access point 112 and into the tank 102. Specifically, the fail-closed valve 104 passes through the vapor space 108 and into the liquid space 110 before terminating proximate to a bottom 105 of the tank 102. The fail-closed valve 104 includes an inlet portion 116 and an outlet portion 118 separated by a valve body 120.

The inlet portion 116 is configured to be operated between an open and a closed position. In the open position, fluid contained within the tank 102 can be removed by internal tank pressure through the valve body 120 to the outlet portion 118 of the valve 104. In the closed position, the inlet portion of the valve 104 is sealed to prevent fluid from entering the valve body 120, thereby preventing the removal of fluid from the tank 102. The inlet portion 116 is portion proximate to the bottom portion 105 of the tank 102. In some embodiments, the inlet portion is about 2 inches from a floor 107 of the tank.

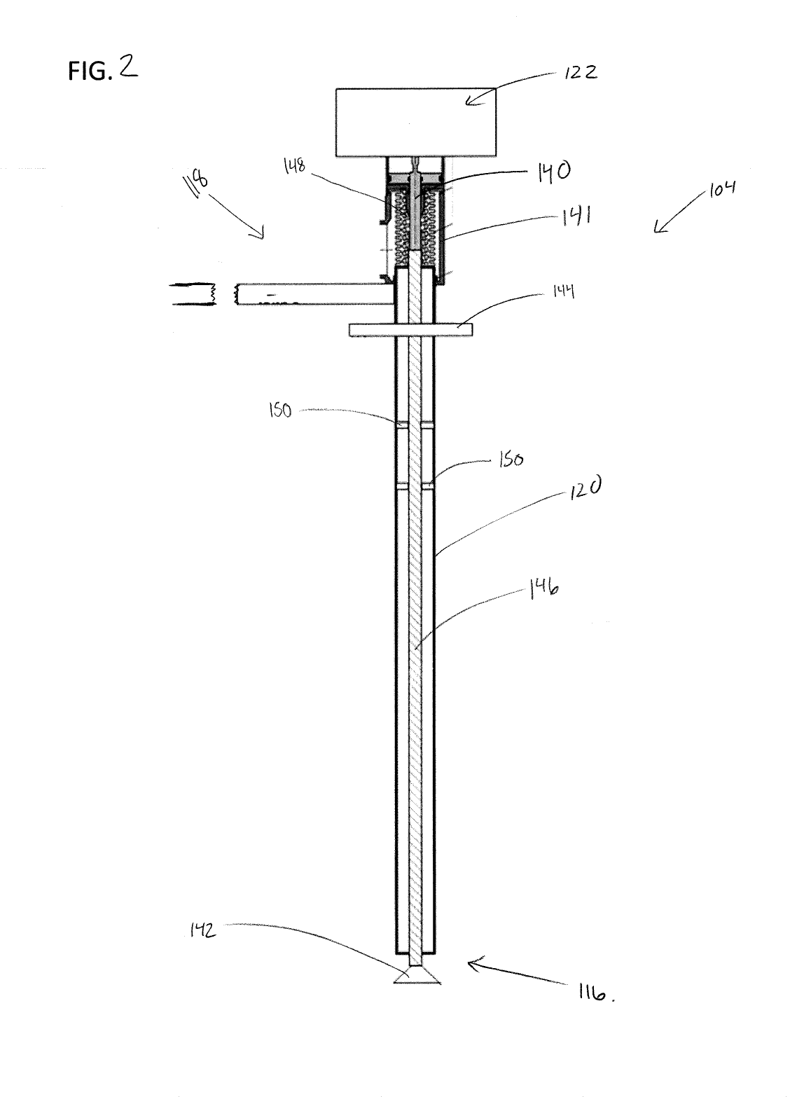

The fail-closed valve 104 is powered by a power system 122 and configured to be in the closed position when not powered. Therefore, when power is removed from the fail-closed valve 104, the inlet portion 116 will be in the closed position and will prevent removal of fluid from the tank 102. The fail-closed valve 104 will be discussed in more detail with respect to FIG. 2.

Also shown in FIG. 1 is a schematic view of the heat exchanger arrangement 106. The heat exchanger arrangement is configured to heat the fluid contained within the tank 102 to facilitate the removal of the fluid from the tank 102. A plurality of heat exchangers of varying types can be utilized in the arrangement 106. In the depicted embodiment, the heat exchanger arrangement 106 includes a first heat exchanger 124, a second heat exchanger 126, a blower 128, and a fluid heater 130 in fluid communication with one another to form a heat exchanger circuit 131. In other embodiments, the first and second heat exchangers 124, 126 are electric heaters controlled by a controller and do not require an external heat exchanger arrangement. In some embodiments, power can be provided to the electric heaters though a feedthrough at the pressure vessel boundary. Additionally, as shown, the blower 128 is configured to move a heat exchanger fluid between the fluid heater 130 and the first and second heat exchangers 124, 126 in a closed-loop configuration to form the heat exchanger circuit 131.

The first heat exchanger 124 is configured to be positioned within the vapor space 108 of the tank 102. In the depicted embodiment, the first heat exchanger 124 receives the heated heat exchanger fluid from a first heat exchanger fluid line 132 that is connected to the fluid heater 130. The heat exchanger fluid is moved through the first heat exchanger 124 by way of the blower 128. Accordingly, the first heat exchanger 124 is configured to heat the vapor space 108 of the tank 102 by transferring heat from the heated heat exchanger fluid to the vapor (gas) contained within the vapor space 108. In some embodiments, the first heat exchanger is a tube heat exchanger.

The second heat exchanger 126 is configured to be positioned within the liquid space 108 of the tank 102. Similar to the first heat exchanger 124, the second heat exchanger 126 is connected to the fluid heater 130 by way of a second heat exchanger fluid line 134. Heat exchanger fluid is also moved through the second heat exchanger 124 by the blower 128, and the second heat exchanger 124 is configured to heat the liquid space 110 by transferring heat from the heated heat exchanger fluid to the liquid contained within the liquid space 110. In some embodiments, the second heat exchanger is a tube heat exchanger. The blower 128 is configured to be in fluid communication with the fluid heater 130 and the first and second heat exchangers 124, 126. In some embodiments, the blower 128 is a compressor. Also, in some embodiments, the operation of the blower 128 can be customized to fit the operating requirements of the heat exchanger arrangement 106. For example, depending on the amount of heat that needs to be transferred to the tank 102, the blower's operation can be altered to achieve the desired heating results. Additionally, the blower 128 can be in communication with a controller that only turns on the blower when a fluid needs to be withdrawn from the tank 102. In some embodiments, the blower 128 is a sealed blower.

The fluid heater 130 is configured to heat the heat exchanger fluid for delivery to the first and second heat exchangers 124, 126. The fluid heater 130 can be a heat exchanger configured to either heat or cool the heat exchanger fluid. In some embodiments, the fluid heater 130 can include a fluid heater fluid used to heat or cool the heat exchanger fluid. In other embodiments, the fluid heater 130 includes an electric heater.

The fluid heater 130 is configured to output a cooled or heated heat exchanger fluid along a fluid heater output line 136. The fluid heater output line 136 is configured to be connected to a heat exchanger valve 138. The heat exchanger valve 138 is configured to allow fluid communication with both the first and second heat exchanger fluid lines 132, 134 at the same time, one at a time, or to prevent fluid communication between the fluid heater output line 138 and the first and second heat exchanger fluid lines 132, 134. The heat exchanger valve 138 allows the heat exchanger arrangement 106 to operate both heat exchangers 124, 126 at the same time, or each one separately.

When operating only the first heat exchanger 124 to heat the tank 102, a liquid is delivered through the valve 104 when pressure reaches a desired level in the tank 102. When operating only the second heat exchanger 126, a saturated liquid is delivered through the valve 104 when pressure reaches a desired level in the tank 102. Saturated liquid is often used for LNG vehicle fuel tanks.

The heat exchanger fluid can be a variety of different fluids. In some embodiments the heat exchanger fluid exists in the heat exchanger arrangement 106 as a liquid, a gas, or both. In one embodiment, the heat exchanger fluid at least partially contains nitrogen. Nitrogen is non-reactive and nonflammable, thereby increasing the overall safety of the system. In the event of a failure in the heat exchanger arrangement 106, a leak of nitrogen gas would not compound issues by being a fire risk around an already flammable fluid, LNG. Other examples of heat exchanger fluids can include ethane, helium, propane, or air. In one embodiment, when air is used as the heat exchanger fluid, the dew point of the air must be kept less at about (−)100 if the air is not recirculated in a closed loop. In some embodiments, the size of the heat exchangers can be adjusted depending on the heat transfer properties of the chosen fluid. Additionally, fluid flow through the system may also be adjusted depending on the heat transfer properties of the chosen fluid.

In some embodiments, the heat exchanger arrangement 106 can include a pressure relief valve (not shown). In such an embodiment, the pressure relief valve operates to relieve pressure in the system due to over pressurization, excessive heat transfer, or failure.

FIG. 2 shows a schematic view of the fail-closed valve 104. As shown the fail-closed valve 104 includes a mounting flange 144 for securing the valve 104 to the tank 102 (as shown in FIG. 1). Due to the compact nature of the valve 104, the valve 104 is configured to be inserted or removed into the tank 102 as a single assembly. This eases maintenance, replacement, and generally simplifies the overall system 100.

The fail-closed valve 104 includes the inlet portion 116, the outlet portion 118, and the power system 122. In the depicted embodiment, the valve 104 also includes an actuator 140, positioned within a spring-loaded cylinder 141, to operate a sealing mechanism 142.

Because the valve body 120 does not need to house a pump, the valve body 120 can be relatively small in size. The valve body 120 can take on a variety of different shaped cross-sections. In some embodiments, the valve body 120 has a circular cross-section with a maximum diameter of less than about 3 inches.

The power system 122 is schematically shown and can include a variety of different power sources. The power system 122 is configured to provide power to facilitate the opening and closing of the valve 104. In one embodiment, the power system 122 can include an electric power source (e.g. a battery) and a controller. In other embodiments, the power system 122 includes a hydraulic power source. In still other embodiments, the power system 122 includes a pneumatic power source.

In the depicted embodiment, the power system 122 is configured to move the actuator 140, and the actuator 140 is configured to move a valve stem 146. The valve stem 146 is positioned within the valve body 120 and connected to the sealing mechanism 142 near the inlet portion 116 of the valve 104. Therefore, as the position of the actuator 140 is altered by the power system 122, the positon of the sealing mechanism 142 is also altered. Specifically, the actuator 140 exerts a force upon the valve stem 146 to move the sealing mechanism 142 to open the inlet portion of the valve 104.

The valve stem 146 is positioned within the valve body 120. In some embodiments, the valve stem 146 can be stabilized within the valve body 120 by use of stabilizers 150. The stabilizers 150 are configured to ensure that the valve stem 146 stays generally centered within the valve body to allow for proper operation of the sealing mechanism 142. The stabilizers 150 can be manufactured from a variety of different materials. For example, Teflon®, brass, or graphite can be used.

The spring loaded cylinder 141 is positioned above the flange 144, and is therefore configured to be positioned outside of the tank 102. In some embodiments, the spring-loaded cylinder 141 is located within the tank 102, below the flange 144. In some embodiments, the spring-loaded cylinder 141 is bellows sealed or inside the tank.

Additionally, the spring-loaded cylinder 141 is shown to include a spring 148 positioned around a portion of the valve stem 146. The spring 148 is configured to exert a pulling force upward on the valve stem 146, in a direction away from the inlet portion 116 of the valve 104. Therefore, when the power system 122 moves the actuator 140 so that the actuator 140 contacts the valve stem 146, the force exerted on the valve stem 146 must be greater than the pulling force of the spring 128 in order to move the valve stem 146. The moment that power is removed from the actuator 140, the spring 141 forces the valve stem 146 in an upward direction, thereby sealing the valve 104. This is an important safety feature as it helps prevent and minimize spills.

The sealing mechanism 142 is shown rigidly attached to the valve stem 146 and in the open position. When in the open position, fluid from within the tank 102 enters the valve body 120 and can be withdrawn at the outlet portion 118. When in the closed positon, the sealing mechanism 142 is configured to form a seal against the valve body 120. The seal is created by the spring 148 exerting an upward force on the valve stem 146, which exerts an upward force on the sealing mechanism 142. In some embodiments, the sealing mechanism 142 has a polished surface to ensure a strong seal against the valve body 120. The sealing mechanism 142 can be of a variety of thicknesses depending on the specific application and pressure within the storage tank 102. Proper thickness will minimize deformation. In other embodiments, the sealing mechanism 142 can be made of a cryogenic rated material, like stainless steel, to allow for ease of polishing. In still other embodiments, the sealing mechanism 142 may take a variety of shapes. These shapes could include, but are not limited to, a cone, a hemisphere, or some other self-centering geometric solid.

In some embodiments, the sealing mechanism 142 or valve body 120 can include a separate seal (not shown). In such embodiments, the separate seal is configured to be compressed between the valve body 120 and the sealing mechanism 142 when the valve 104 is in the closed positon. In some embodiments, the seal can be spring-energized. In other embodiments, the seal can be an O-ring or other type of static seal designed for LNG/cryogenic service. In other embodiments still, the seal can be made of an elastomer that retains some flexibility at cryogenic temperatures, such as Teflon®, Kevlar®, Kel-F®, Nylon®, etc.

Though not shown, the cryogenic system 100 can include a plurality of sensors positioned throughout the system 100. Types of sensors can include pressure sensors, fluid flow sensors, and/or temperatures sensors. Such sensors can provide input to a system control unit. The control unit can use such input data for a variety of uses such as to sound an alarm or adjust the operating characteristics of the system 100.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

We claim:

1. A cryogenic tank system comprising:
a storage container having a top portion and a bottom portion, the storage container also being configured to store a liquid within an enclosed interior volume, wherein a level of the liquid within the interior volume defines a liquid space and a vapor space;
a heat exchanger arrangement including:
a heat exchanger heater positioned external to the storage container and connected to a heat exchanger fluid circuit;
a first heat exchanger located in the vapor space within the storage container and in fluid communication with the heat exchanger heater along the heat exchanger fluid circuit;
a second heat exchanger located in the liquid space within the storage container and in fluid communication with the heat exchanger heater along the heat exchanger fluid circuit;
wherein heat transfer to the vapor space and the liquid space by the first and second heat exchangers pressurizes the interior volume of the storage container; and
a valve assembly mounted to the top portion of the storage container and positioned substantially within the storage container, the valve assembly including an inlet portion and an outlet portion, the outlet portion being positioned outside of the storage container, and the inlet portion being positioned within the storage container proximate to the bottom portion of the storage container, and wherein the inlet portion is sealable by a fail-closed powered sealing mechanism.

2. The cryogenic tank system of claim 1, wherein the first heat exchanger is configured to transfer heat from the heat exchanger fluid circuit to the vapor space, and wherein the second heat exchanger configured to transfer heat from the heat exchanger fluid circuit to the to the liquid space.

3. The cryogenic tank system of claim 1, wherein the valve assembly includes an actuator connected to the fail-closed powered sealing mechanism, and wherein the actuator is configured to open and close the fail-closed powered sealing mechanism.

4. The cryogenic tank system of claim 3, wherein the actuator is a pneumatic powered actuator.

5. The cryogenic tank system of claim 3, wherein the actuator is a hydraulic powered actuator.

6. The cryogenic tank system of claim 1, wherein the heat exchanger fluid circuit includes a heat exchanger fluid, the heat exchanger fluid being at least partially comprised of nitrogen.

7. The cryogenic tank system of claim 1, wherein the heat exchanger arrangement further includes a blower in fluid communication with the heat exchanger fluid circuit.

8. A method of removing a fluid from a cryogenic storage container comprising:
heating a heat exchanger fluid at a heat exchanger heater, the heat exchanger heater positioned externally to the cryogenic storage container and connected to a heat exchanger fluid circuit;
pressurizing the storage container by transferring heat from a first heat exchanger positioned within the vapor space of the storage container and connected to the heat exchanger fluid circuit;
opening an inlet portion of a valve assembly by delivering power to a fail-closed powered sealing mechanism positioned at the inlet portion of the valve assembly; and
withdrawing a fluid from an outlet portion of the valve assembly.

9. The method of claim 8, wherein the first heat exchanger is heated by delivering the heated heat exchanger fluid to the first heat exchanger.

10. The method of claim 8, wherein the fluid withdrawn from the storage container is liquefied natural gas.

11. The method of claim 8, further comprising heating a liquid space in a storage container by transferring heat from a second heat exchanger positioned in the liquid space of the storage container.

12. The method of claim 11, wherein the second heat exchanger is heated by delivering the heated heat exchanger fluid to the second heat exchanger.
